(19) United States
(12) Patent Application Publication
(10) Pub. No.: US 2011/0186414 A1
(43) Pub. Date: Aug. 4, 2011

(54) DOME SWITCH INTEGRATED TOUCH WINDOW FOR MOBILE TERMINAL

(75) Inventors: Ki-Ung KIM, Incheon-si (KR); Sung-June PARK, Seoul (KR); Han-Su YANG, Seoul (KR); Choon-Shik LEE, Seoul (KR)

(73) Assignee: PANTECH CO., LTD., Seoul (KR)

(21) Appl. No.: 12/876,022

(22) Filed: Sep. 3, 2010

(30) Foreign Application Priority Data
Feb. 4, 2010 (KR) 10-2010-0010572

(51) Int. Cl. H01H 1/10

(52) U.S. Cl. 200/512

(57) ABSTRACT

A dome switch integrated touch window for a mobile terminal includes a lower substrate, a dome switch, a spacer sheet, and an upper substrate. A dome switch is disposed on a lower substrate to correspond to a contact terminal. The dome switch extends through a spacer sheet and an upper substrate disposed on the spacer sheet. The dome switch is covered by a design film. The dome switch includes an operation member having a resilient base disposed over the contact terminal and a resilient protrusion projecting from the resilient base, and a dome disposed between the operation member and the lower substrate. The operation member may have an upwardly concaved dome-shaped groove to receive the dome.

### CROSS-REFERENCE TO RELATED APPLICATION

This application claims priority from and the benefit under 35 U.S.C. §119(a) of Korean Patent Application No. 10-2010-0010572, filed on Feb. 4, 2010, in the Korean Intellectual Property Office, the disclosure of which is incorporated by reference for all purposes.

### BACKGROUND

1. Field

The following description relates to a touch window having a dome switch for a mobile terminal.

2. Discussion of the Background

Mobile phones, one kind of mobile terminal, are widely used as personal communication terminals through which voice communication and wireless communication are is possible while moving. The mobile phones are being developed as products capable of performing various functions, for example, functions of a multimedia player, a digital camera, a digital multimedia broadcasting (DMB) receiver, a personal digital assistant (PDA), etc., as well as communication, to satisfy various demands of users. Screens of the mobile phones having various functions are being increased in size due to an increase in appreciation of multimedia or DMB content.

Mobile phones including touch windows have been widely released. The touch windows may be disposed at the screens of the mobile phones to enable touch input of commands through input windows in the screens. When the touch windows replace input buttons conventionally provided in keypads, for example, input buttons for various inputs including character/number inputs, these input buttons may be omitted from the keypad. Therefore, a region of the keypad in the mobile phone can be reduced, and the reduced region can be used to enlarge a screen of the mobile phone.

While the mobile phone may be constituted by removing all input buttons of the keypad and implementing all functions of the input buttons using the touch window, when a certain function of button, in particular, a power button is provided in the touch window, malfunction may occur. Therefore, the power button may be provided as a dome switch.

FIG. 6 is a partial cross-sectional view of a conventional dome switch. As shown in FIG. 6, a dome switch 20 includes a dome sheet 24 having a dome-shaped upward concave groove formed therein. A dome 25 is fixed to or disposed on an inner wall of the groove of the dome sheet 24. In addition, an operation member 21 includes a base 22 disposed on the dome sheet 24, and a protrusion 23 protruding downwardly from the base 22 toward the groove of the dome sheet 24.

Both a touch window and a dome switch type keypad may be provided in a mobile phone. Here, the keypad includes a power button, a call button, and a cancellation button. In the case of a bar-type mobile phone, in general, the touch window is disposed at a front surface of the mobile phone, and the keypad is separately disposed at a lower end of the touch window.

However, as described above, when the touch window and the keypad are separately provided, foreign substances such as dust, etc., may become stuck between the touch window and the keypad. In order to prevent the foreign substances from becoming stuck, an additional design film may be provided to cover and protect the touch window and the keypad. In addition, since the touch window and the keypad are separately provided, the number of parts is increased.

For another example, a structure in which a touch window is mounted on a front surface of a mobile phone and a dome switch type power button is separately disposed at a side surface of the mobile phone has been proposed. However, even in this case, since the power button, etc., must be separately provided from the touch window, the number of parts is also increased.

### SUMMARY

Exemplary embodiments of the present invention provide a dome switch integrated touch window for a mobile terminal.

Additional features of the invention will be set forth in the description which follows, and in part will be apparent from the description, or may be learned by practice of the invention.

An exemplary embodiment provides a dome switch integrated touch window including: a lower substrate including a lower transparent conductive layer disposed on an upper surface of the lower substrate to correspond to a touch operation region, and a contact terminal disposed on the upper surface of the lower substrate; a dome switch disposed on the lower substrate to correspond to the contact terminal; a spacer sheet including an opening corresponding to the lower transparent conductive layer and the contact terminal, and disposed on the upper surface of the lower substrate; and an upper substrate disposed on an upper surface of the spacer sheet and including an upper transparent conductive layer disposed on a lower surface of the upper substrate to correspond to the lower transparent conductive layer.

An exemplary embodiment provides a mobile terminal including: a dome switch integrated touch window, including: a lower substrate including a lower transparent conductive layer disposed on an upper surface of the lower substrate to correspond to a touch operation region, and a contact terminal disposed on the upper surface of the lower substrate; a dome switch disposed on the lower substrate to correspond to the contact terminal; a spacer sheet including an opening corresponding to the lower transparent conductive layer and the contact terminal, and disposed on the upper surface of the lower substrate; and an upper substrate disposed on an upper surface of the spacer sheet and including an upper transparent conductive layer disposed on a lower surface of the upper substrate to correspond to the lower transparent conductive layer.

It is to be understood that both the foregoing general description and the following detailed description are exemplary and explanatory and are intended to provide further explanation of the invention as claimed. Other features will become apparent to those skilled in the art from the following detailed description, which, taken in conjunction with the attached drawings, discloses exemplary embodiments of the invention.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of a mobile terminal including a dome switch integrated touch window in accordance with an exemplary embodiment of the present invention.

FIG. 2 is an exploded perspective view of the dome switch integrated touch window shown in FIG. 1.

FIG. 3 is a partial cross-sectional view taken along line A-A of FIG. 1.

FIG. 4 is a partial cross-sectional view taken along line B-B of FIG. 1.

FIG. 5 is a cross-sectional view of the dome switch of FIG. 4.

FIG. 6 is a partial cross-sectional view of a conventional dome switch.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. When an element is described as “connected to” or “disposed on” another element, the element may be directly connected to or directly disposed on the other element or intervening elements may be present.

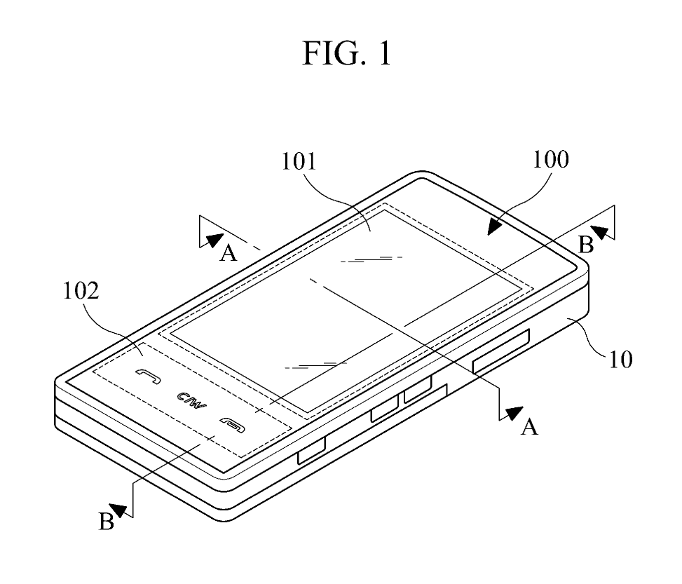

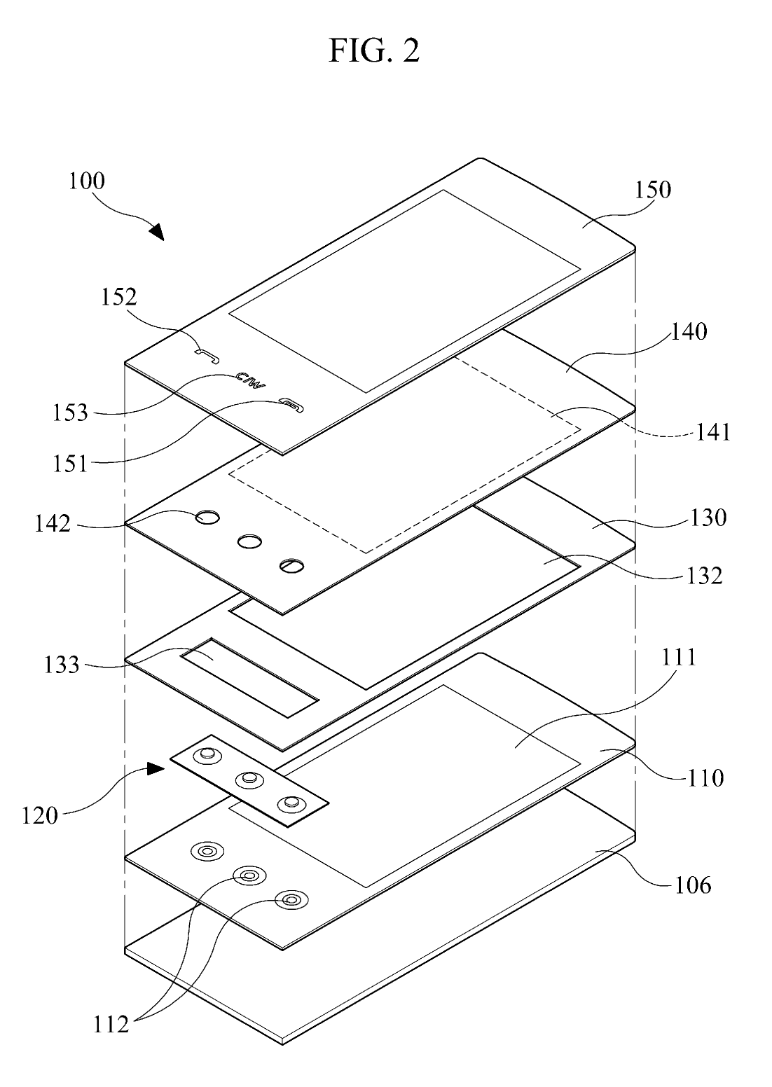

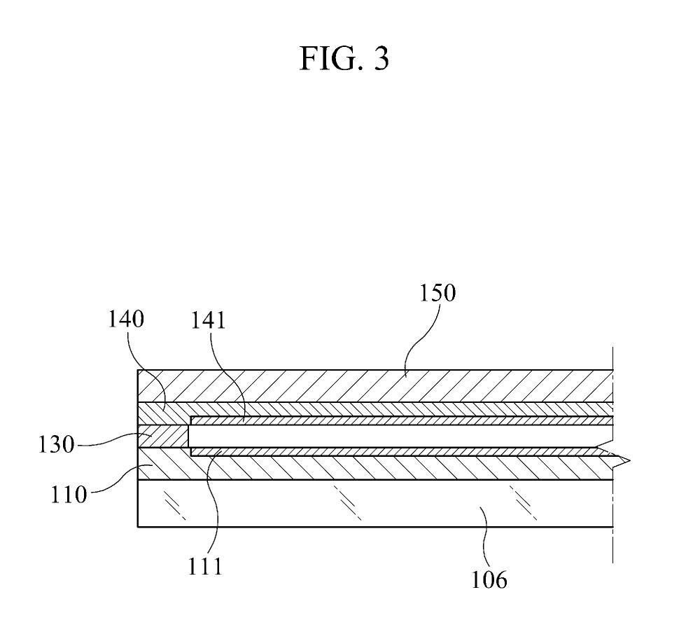

FIG. 1 is a perspective view of a mobile terminal including a dome switch integrated touch window in accordance with an exemplary embodiment, FIG. 2 is an exploded perspective view of the dome switch integrated touch window shown in FIG. 1, and FIG. 3 is a partial cross-sectional view taken along line A-A of FIG. 1.

Referring to FIG. 1, a dome switch integrated touch window 100 is disposed at a front surface of a mobile terminal, for example, a mobile phone 10, and includes a touch operation region 101 and a dome operation region 102. The touch operation region 101 is disposed to correspond to a screen of the mobile phone 10. The touch operation region 101 corresponds to a region in which a user inputs commands through an input window in the screen by a touch.

The dome operation region 102 is disposed at one side of the touch operation region 101, for example, a lower side outside the screen. The dome operation region 102 corresponds to a region in which a user inputs commands by a dome switch. As described above, the dome switch integrated touch window 100 is a structure in which the touch window is integrally formed with the dome switch so that commands may be input by the dome switch as well as the touch.

As shown in FIG. 2, the dome switch integrated touch window 100 includes a lower substrate 110, a dome switch 120, a spacer sheet 130, and an upper substrate 140.

The lower substrate 110 includes a lower transparent conductive layer 111 formed on or disposed on an upper surface thereof to correspond to or align with the touch operation region 101. The lower transparent conductive layer 111 may have a thickness and be formed of a transparent conductive material, for example, an indium tin oxide (ITO) material, over the entire region corresponding to or aligning with the touch operation region 101. Further, the lower substrate 110 may also be transparent.

The lower transparent conductive layer 111 is electrically connected to an upper transparent conductive layer 141 and may output a voltage value varied by a resistance value at the touched position if a user touches and pushes one or more regions of the touch operation region 101. The output voltage value may be provided to a controller (not shown), and the controller may recognize position coordinates of the touch on the basis of the provided voltage value.

The lower substrate 110 includes at least one contact terminal 112 disposed at a side of an upper surface of the lower transparent conductive layer 111. The contact terminal 112 is electrically connected to a conductive area of the dome switch 120 to output an electrical signal if a user pushes the dome switch 120. The output electrical signal may be provided to the controller, and the controller may recognize the input through the dome switch 120 on the basis of the electrical signal.

The lower substrate 110 may be fixed to or disposed on a transparent support plate 106. The transparent support plate 106 may support the lower substrate 110 and members disposed thereon. The transparent support plate 106 may be formed of a transparent material, for example, a glass material.

The dome switch 120 is disposed on the lower substrate 110 to correspond to or align with the contact terminal 112. The dome switch 120 is deformed to be electrically connected to the contact terminal 112 if pushed by a user, and the dome switch 120 is returned to an original shape to maintain a state separated from the contact terminal 112 if the pushed state is released. That is, the dome switch 120 varies a contact state with the contact terminal 112 depending on a push of the dome switch 120.

The spacer sheet 130 is fixed to or disposed on the upper surface of the lower substrate 110. In addition, the spacer sheet 130 includes an opening 132 corresponding to or aligning with the lower transparent conductive layer 111. Therefore, in a state in which the upper substrate 140 is fixed to or disposed on the upper surface of the spacer sheet 130, the lower transparent conductive layer 111 and the upper transparent conductive layer 141 may be spaced apart from each other with an air layer disposed therebetween. That is, the lower transparent conductive layer 111 and the upper transparent conductive layer 141 may be spaced from each other by the spacer sheet 130 if there is no touch operation on the touch operation region 101.

In addition, the spacer sheet 130 includes an opening 133 corresponding to or aligning with the contact terminal 112 so that the dome switch 120 may extend through the opening 133 of the spacer sheet 130 and be disposed on the contact terminal 112. The spacer sheet 130 may be formed of a double-sided tape. Although the opening 132 and the opening 133 of the spacer sheet 130 is shown in FIG. 2 as two separate openings, aspects are not limited thereto such that the opening may be one opening only, or greater than two openings.

The upper substrate 140 is fixed to or disposed on an upper surface of the spacer sheet 130. The upper substrate 140 includes the upper transparent conductive layer 141 formed on or disposed on a lower surface of the upper substrate 140 to correspond to or align with the lower transparent conductive layer 111. The upper transparent conductive layer 141 may have a thickness and be formed of a transparent conductive material, for example, an ITO material, over the entire region corresponding to or aligning with the touch operation region 101. Further, the upper substrate 140 may be transparent.

The upper transparent conductive layer 141 is pushed to be electrically connected to the lower transparent conductive layer 111 if a user touches and pushes one or more regions of the touch operation region 101, and may output a voltage value varied depending on a resistance at the touched position. However, aspects are not limited thereto such that the lower transparent conductive layer 111 may be pushed to be electrically connected to the upper transparent conductive layer 141 to output the voltage value or both the upper transparent conductive layer 141 and the lower transparent conductive layer 111 may be pushed to be electrically connected to output the voltage value. The output voltage value may be provided to a controller, and the controller may recognize position coordinates of the touch in the touch operation region 101.

The lower transparent conductive layer 111 for recognizing a touch operation and the contact terminal 112 for recognizing a dome operation are disposed on the lower substrate 110. In addition, the dome switch 120 is disposed between the lower substrate 110 and the upper substrate 140 to correspond to or align with the contact terminal 112. Thus, the dome switch 120 is provided as an integrated structure in the touch window 100.

According to this arrangement, there may be no need to provide an additional design film to prevent foreign substances from becoming inserted in a gap between the keypad and the touch window, unlike the conventional structure.

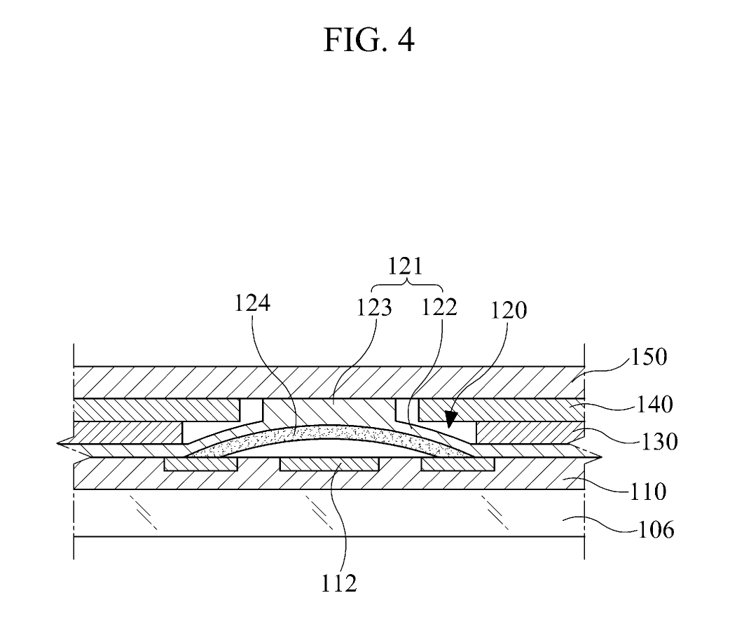

The upper substrate 140 includes a through-hole 142 through which an upper part of the dome switch 120, i.e., a resilient protrusion 123 as shown in FIG. 4, passes. A design film 150 may be fixed to or disposed on the entire upper surface of the upper substrate 140. The design film 150 may cover and protect the upper substrate 140 and the resilient protrusion 123 exposed through the through-hole 142, and can prevent foreign substances from being inserted into a gap between the resilient protrusion 123 and the through-hole 142. The resilient protrusion 123 is disposed to pass through the upper substrate 140 and is covered by the design film 150.

In addition, the contact terminal 112 may include a contact terminal for a power button. A power on/off function of the mobile phone may be performed by the power button operated in a dome switch type. The contact terminal for a power button may also be or alternatively be a contact terminal for a call end button of the mobile phone 10.

The contact terminal may further include a contact terminal for a call button and a contact terminal for a cancellation button. Therefore, a call function and a cancellation function of the mobile phone 10 may be performed by the call button and the cancellation button operated in as a dome switch. In this case, the design film 150 may include a power button icon 151, a call button icon 152, and a cancellation button icon 153 corresponding to or aligning with the contact terminal for a power button, the contact terminal for a call button, and a contact terminal for a cancellation button, respectively. In another arrangement, one or more of these functions may be performed by a single contact terminal, and the different functions performed by the single contact terminal may depend on the length of time that a user maintains an input, or according to a menu selection, or according to conditions recognized by the controller.

As shown in FIG. 3, the lower transparent conductive layer 111 and the upper transparent conductive layer 141 may be recessed in the lower substrate 110 and the upper substrate 140, respectively; however, aspects are not limited thereto such that either or both of lower transparent conductive layer 111 and the upper transparent conductive layer 141 may be not recessed in the lower substrate 110 and the upper substrate 140, respectively.

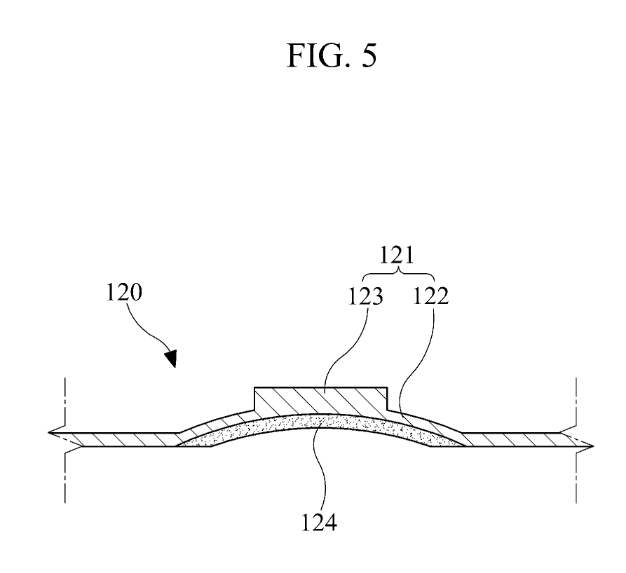

Meanwhile, the dome switch 120 may be configured as shown in FIG. 4 and FIG. 5. FIG. 4 is a partial cross-sectional view taken along line B-B of FIG. 1. FIG. 5 is a cross-sectional view of the dome switch of FIG. 4. As shown in FIG. 4 and FIG. 5, the dome switch 120 includes an operation member 121 and a dome 124. The dome 124 may be a metal dome but aspects are not limited thereto.

The operation member 121 includes a resilient base 122 and a resilient protrusion 123. The resilient base 122 is fixed or disposed around or over the contact terminal 112, and comprises an upwardly concaved dome-shaped groove formed over the contact terminal 112. The resilient protrusion 123 projects upward from an upper surface of the resilient base 122 corresponding to or aligning with the dome-shaped groove. The resilient protrusion 123 may be integrally formed with the resilient base 122. The operation member 121 may have a structure in which the resilient base 122 and the resilient protrusion 123 are formed of a resilient material, for example, rubber, and are integrally formed with each other.

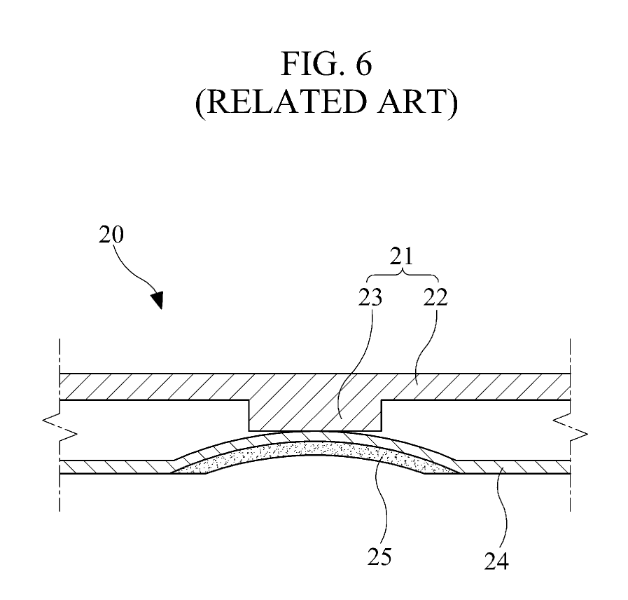

The dome 124 includes an upwardly convex dome shape, and is fixed to or disposed on an inner wall of the upwardly concaved dome-shaped groove of the operation member 121. The dome 124 may be formed of a metal material having a conductivity to be electrically connected to the contact terminal 112 when the dome 124 is pressed. The contact terminal 112 may be recessed into the lower substrate 110 so that an upper surface of the contact terminal 112 is flush with an upper surface of the lower substrate 110, but aspects are not limited thereto. An entire thickness of the dome switch 120 may be smaller than that of a conventional dome switch 20 as shown in FIG. 6.

The dome switch 120 includes a structure in which the resilient protrusion 123 projects from an upper end of the resilient base 122 covering the dome 124 such that it is possible to reduce the thickness of the dome switch 120 to the thickness of the base 22 or the dome sheet 24 of the conventional dome switch 20 as shown in FIG. 6.

Therefore, even when a space between the lower transparent conductive layer 111 and the upper transparent conductive layer 141 is set as small as 0.1 mm to decrease a thickness of the touch window 100, the dome switch 120 of the embodiment may be more readily applied than the conventional dome switch 20. In addition, since there is no need to widen a space between the lower transparent conductive layer 111 and the upper transparent conductive layer 141, such as is required with the conventional dome switch 20, it is possible to improve click feeling and recognition upon operation of the dome switch 120.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A dome switch integrated touch window, comprising:
a lower substrate comprising a lower transparent conductive layer disposed on an upper surface of the lower substrate to correspond to a touch operation region, and a contact terminal disposed on the upper surface of the lower substrate;
a dome switch disposed on the lower substrate to correspond to the contact terminal;
a spacer sheet comprising an opening corresponding to the lower transparent conductive layer and the contact terminal, and disposed on the upper surface of the lower substrate; and
an upper substrate disposed on an upper surface of the spacer sheet and comprising an upper transparent conductive layer disposed on a lower surface of the upper substrate to correspond to the lower transparent conductive layer.

2. The dome switch integrated touch window of claim 1, wherein the dome switch comprises:
an operation member comprising a resilient base disposed over the contact terminal, and a resilient protrusion projecting from an upper surface of the resilient base; and
a dome disposed between an inner wall of the operation member and the lower substrate.

3. The dome switch integrated touch window of claim 2, wherein the upper substrate comprises a through-hole through which the resilient protrusion extends.

4. The dome switch integrated touch window of claim 2, further comprising:
a design film disposed on the upper substrate to cover an upper surface of the upper substrate.

5. The dome switch integrated touch window of claim 1, wherein the contact terminal comprises a first contact terminal for a power button.

6. The dome switch integrated touch window of claim 5, wherein the contact terminal comprises a second contact terminal for a call button and a third contact terminal for a cancellation button.

7. The dome switch integrated touch window of claim 1, wherein the opening comprises:
a first opening corresponding to the lower transparent conductive layer and a second opening corresponding to the contact terminal.

8. The dome switch integrated touch window of claim 1, wherein lower transparent conductive layer is recessed into the upper surface of the lower substrate and the upper transparent conductive layer is recessed into the lower surface of the upper substrate.

9. The dome switch integrated touch window of claim 1, wherein the contact terminal is recessed into the upper surface of the lower substrate.

10. The dome switch integrated touch window of claim 1, wherein the dome switch comprises:
an operation member comprising a resilient base disposed over the contact terminal, and a resilient protrusion projecting from an upper surface of the resilient base.

11. The dome switch integrated touch window of claim 1, wherein the dome switch comprises:
an operation member comprising an upwardly concaved dome-shaped groove formed over the contact terminal.

12. The dome switch integrated touch window of claim 11, wherein the dome switch comprises:
a dome disposed between the upwardly concaved dome-shaped groove of the operation member and the lower substrate.

13. The dome switch integrated touch window of claim 11, wherein the dome switch comprises a metal dome switch.

14. A mobile terminal, comprising:
a dome switch integrated touch window, comprising:
a lower substrate comprising a lower transparent conductive layer disposed on an upper surface of the lower substrate to correspond to a touch operation region, and a contact terminal disposed on the upper surface of the lower substrate;
a dome switch disposed on the lower substrate to correspond to the contact terminal;
a spacer sheet comprising an opening corresponding to the lower transparent conductive layer and the contact terminal, and disposed on the upper surface of the lower substrate; and
an upper substrate disposed on an upper surface of the spacer sheet and comprising an upper transparent conductive layer disposed on a lower surface of the upper substrate to correspond to the lower transparent conductive layer.
